(19) United States
(12) Patent Application Publication
(10) Pub. No.: US 2024/0253950 A1
(43) Pub. Date: Aug. 1, 2024

(54) ARRANGEMENT AND METHOD FOR INSTALLING GUIDE RAILS OF AN ELEVATOR

(71) Applicant: Kone Corporation, Helsinki (FI)

(72) Inventors: Eetu KEJONEN, Helsinki (FI); Gert VAN DER MEIJDEN, Helsinki (FI); Rob ARENDS, Helsinki (FI)

(73) Assignee: Kone Corporation, Helsinki (FI)

(21) Appl. No.: 18/632,765

(22) Filed: Apr. 11, 2024

Related U.S. Application Data
(63) Continuation of application No. PCT/FI21/50697, filed on Oct. 19, 2021.

(51) Int. Cl. B66B 19/00

(52) U.S. Cl. CPC B66B 19/002

(57) ABSTRACT

An arrangement and method for installing guide rails of an elevator. The arrangement comprises an installation platform movable vertically in an elevator shaft and one or more guide rail baskets hanging below a floor of the installation platform for carrying guide rail elements vertically. The several guide rail elements are transported in one transport drive from a lower loading level to a higher installation level by means of the arrangement. This way, several successive sections of the guide rails can be installed at the installation level.

### CROSS-REFERENCE TO RELATED APPLICATION

This application is a continuation of PCT International Application No. PCT/FI2021/050697 which has an International filing date of Oct. 19, 2021, the entire contents of which are incorporated herein by reference.

### BACKGROUND OF THE INVENTION

The invention relates to installation of vertical guide rails of an elevator to an elevator shaft. More specifically the invention relates to an arrangement for assisting transporting the guide rails at an installation site.

The invention further relates to a method for installing guide rails to an elevator shaft.

The field of the invention is defined more specifically in the preambles of the independent claims.

An elevator car of an elevator is supported to vertical guide rails which are mounted on surfaces of an elevator shaft. Typically, the guide rails are profile elements with a certain length. The length may be 2-3 m, for example. For assisting mounting of the guide rails and other elevator components, installation platforms are arranged to the elevator shafts. The installation platform can be moved vertically in the elevator shaft for transporting the guide rails and components. When the elevators are installed to high-rise buildings with height 200 m or more, number of the required guide rails is great. The installation work of the guide rails requires repetitive driving of the installation platform from a basic lower level to a higher installation level. For example, in a 250 m high elevator shaft, it may take totally over 70 hours just for driving the installation platform up and down because in the very high elevator shaft driving up and down takes time. In the high-rise buildings the guide rail installation is one of the most time consuming work phases of the total installation project of the elevator. There are solutions for providing the installation platforms with support elements for supporting guide rail elements on them. However, the known solutions have shown to contain some disadvantages.

### BRIEF DESCRIPTION OF THE INVENTION

An object of the invention is to provide a novel and improved arrangement and method for installing guide rails of an elevator to an elevator shaft.

The arrangement according to the invention is characterized by the characterizing features of the independent apparatus claim.

The method according to the invention is characterized by the characterizing features of the independent method claim.

An idea of the disclosed solution is that transport measures of guide rail elements are facilitated by means of an arrangement comprising an installation platform and a guide rail basket suspended below the installation platform. The installation platform can be driven vertically in an elevator shaft and the guide rail basket moves together with it. The guide rail basket comprises a bottom surface or support for supporting the vertically transported guide rail elements. The arrangement is designed for carrying several guide rail elements simultaneously.

In other words, the guide rail basket is hanging in the elevator shaft below the vertically movable installation platform, or other installation structure, and provides vertical support for the vertically orientated guide rail elements needed in the installation work. Thus, the guide rail elements are transported below the installation platform, or at least partly below it, from a lower loading level to a higher installation level.

An advantage of the disclosed guide rail basket is that the installation work is facilitated and quickened. When the time required for the guide rail installation can be decreased, then installation time of the entire elevator can be shortened, and installation costs can be lower. A need for repetitive transport driving of the installation platform is decreased since several guide rails can be transported in one go. In other words, the disclosed solution reduces amount of non-productive work while driving up and down in the elevator shaft.

Further, the disclosed solution can be implemented when installing different type of elevators and different type of guide rails.

A further advantage is that the structure of the disclosed solution is simple, inexpensive, and durable.

Moreover, safety of the transporting phase of the guide rail elements can be improved when the guide rail elements are hanging at least partly below a floor of the installation platform on which a fitter is located. Then the guide rail elements cannot fall on the fitter in any situation.

According to an embodiment, the vertical distance between the guide rail basket and the installation platform is minor than length of the guide rail elements.

According to an embodiment, the guide rail basket is a separate structure relative to the installation platform and is therefore provided with mountable and dismountable connecting means. Thus, the guide rail basked is releasably mountable to the installation platform. There may be quick coupling means for executing the mounting and dismounting of the guide rail basket quickly and easily. An advantage of this solution is that the guide rail basket can be removed after the guide rail installation is completed, whereafter the installation platform can be implemented for other installation work phases without the guide rail basket. Further, the guide rail basket is easy to transport to the installation site when it is a separate piece. Because the guide rail basket has the separate and relatively low weight structure, it is also easy to handle manually at the bottom of the shaft when the installation work is started and completed.

According to an embodiment, the guide rail basket is supported to horizontal support bars of the installation platform. Alternatively, bottom of the installation platform may be provided with suitable loops or fastening points.

According to an embodiment, the installation platform comprises at least one support opening through which upper parts of the vertical guide rail elements are configured to pass and extend above a floor surface of the installation platform. Thus, the first ends of the vertical guide rail elements are supported on the bottom surface of the guide rail basket and their opposite second end portions are configured to pass through the installation platform. The guide rail elements are stabile since the bottom surface of the guide rail basket receives vertical forces and the opposite end portions of the guide rail elements are supported laterally against fall by means of the support openings.

In other words, the guide rail elements are in standing orientation on the guide rail basket and their upper end portions extend above a bottom or floor surface of the installation platform whereby the guide rail elements can be gripped from the installation platform.

The support openings can be manufactured relatively easily by cutting suitably dimensioned and shaped openings to a floor of the installation platform. Alternatively, plates or floor elements with pre-cut openings may be implemented.

According to an embodiment, the installation platform comprises several dedicated support openings whereby upper parts of each guide rail is supported separately to the installation platform. Shapes of each support openings correspond to cross-sectional shapes of the guide rail elements. In other words, each guide rail element passes through a dedicated support opening. An advantage of this embodiment is that the guide rail elements are properly supported, and their handling is easy and safe.

According to an embodiment, there is a support opening through which several guide rail elements are configured to pass. In other words, there is no dedicated support opening for each guide rail element.

According to an embodiment, the guide rail basket is supported below the installation platform by means of several bendable supports. Further, lengths of the mentioned supports are dimensioned so that the vertical distance between the bottom surface of the guide rail basket and a floor of the installation platform is shorter than lengths of the guide rail elements. An advantage of this embodiment is that the upper end portions of the guide rail elements then extend above the floor of the installation platform and are then well reachable.

According to an embodiment, the bendable supports may be chains, ropes, or wires, for example.

According to an embodiment, the guide rail basket is supported to the installation platform by means of bars or corresponding vertical elements.

According to an embodiment, there is an apparatus for moving the guide rail basket vertically in relation to the floor of the installation platform. The apparatus may be a winch, for example. Then the distance can be adjusted in accordance with the length of the used guide rail elements, and further, it is possible that the guide rail elements are totally below the floor during the transport drive and lifted upwards by the apparatus at the installation level so that gripping is facilitated.

According to an embodiment, the guide rail basket is dimensioned to carry weight of 2-6 guide rail elements.

According to an embodiment, size of the bottom surface of the guide rail basket is dimensioned to receive end surfaces of 2-6 vertical guide rail elements. Thus, an area of the bottom surface of the guide rail basket is significantly smaller than an area of the floor of the installation platform.

According to an embodiment, number of the carried guide rail elements per one guide rail basket may be four, and the installation platform may be provided with two guide rail baskets. Then, the arrangement is configured to transport eight guide rail elements in total. When the lengths of the guide rail elements are 2.5 m or more, then the fitters can provide 10 m or more of the elevator shaft with two guide rails without a need to drive down to pick up more guide rail elements.

According to an embodiment, the guide rail basket comprises side supports extending above the bottom surface of the guide rail basket. In other words, the guide rail basket comprises not only the bottom surface but also wall structures, such as bars, cages, or side plates. Then the lower ends of the guide rail elements are secured and are not able to move sideways away from the guide rail basket in any situation. Further, upper portions of the side supports may serve as fastening points for the supporting chains, wires, or other bendable supports.

According to an embodiment, the bottom surface of the guide rail basket may comprise protrusions, tubes, walls, or other elements for providing end portion of each guide rail element a dedicated support area. The support area may then provide at least some lateral support for the guide rail element. In other words, the bottom surface is not flat but comprises designed areas for the ends of the several guide rail elements.

According to an embodiment, the installation platform is provided with two guide rail baskets. In other words, the installation platform may totally support 12 guide rails when one guide rail basket is dimensioned for up to 6 guide rails.

According to an embodiment, the installation platform may alternatively be provided with only one guide rail basket.

According to an embodiment, the installation platform is a temporary installation structure which is configured to be removed from the elevator shaft after the installation work is completed.

According to an embodiment, the installation platform is at least partly left to the elevator shaft after the installation work. Thus, the installation platform may comprise components which are part of a final elevator car.

According to an embodiment, the disclosed solution relates to a method of installing guide rails of an elevator. The method comprises: providing the elevator shaft with an installation platform at least for the duration of the installation of the elevator; transporting guide rail elements in the elevator shaft by means of the installation platform between a loading level and installation level, wherein the loading level has lower level in the elevator shaft compared to the installation level; and installing the guide rail elements to wall structures of the elevator shaft at the installation level by means of at least one fitter travelling onboard the installation platform. The method further comprises hanging several guide rail elements vertically at least partly below the installation platform during the transport.

According to an embodiment, the method comprises loading the guide rail elements at a first floor landing. Then the first floor landing serves as the loading level and may be provided with a storage area and a special loading opening or door.

According to an embodiment, the method comprises loading the guide rail elements at any floor landing being at lower level than the installation floor level or working level.

According to an embodiment, the method comprises suspending at least one guide rail basket below the installation platform and supporting lower ends of the vertical guide rail elements on the guide rail basket.

According to an embodiment, the method comprises mounting and dismounting the guide rail basket at a pit of the elevator shaft.

According to an embodiment, the method comprises supporting upper end portions of the vertical guide rail elements in lateral direction by means of a structure of a floor of the installation platform.

According to an embodiment, the method comprises: providing a floor of the installation platform with several dedicated support openings each of which receives one guide rail element; feeding the guide rail elements through the dedicated support openings in downward direction towards a bottom surface of a guide rail basket; and carrying the guide rail elements in vertical direction only by support forces produced by the bottom surface of the guide rail basket.

According to an embodiment, the method comprises: setting vertical distance between a bottom surface of the guide rail basket and a floor of the installation platform to be shorter than lengths of the transported guide rail elements whereby upper ends of the guide rail elements protrude above an upper surface of the floor; gripping each guide rail element by means of a gripper at the protruding portion and lifting the guide rail element above the floor by means of a temporary hoister; positioning the guide rail element vertically on top of an already installed topmost guide rail element, whereby the guide rail element is set on the row of already installed guide rail elements; aligning the guide rail elements end-on-end one after the other; attaching the successive guide rail elements to each other with connection pieces extending between the end portions of two consecutive guide rail elements; and fastening the guide rail elements to walls of the elevator shaft with fixing means at support points along the height of the guide rail elements.

According to an embodiment, the mentioned gripper may be a guide rail lifting clamp.

According to an embodiment, the mentioned temporary hoist may be a material hoist. Type of the hoist may be a rope hoist.

According to an embodiment, the method comprises: providing the installation platform with a protective roof; providing the protective roof with an openable hatch; and loading the guide rail elements on the arrangement via the hatch.

According to an embodiment, the hatch may be a sliding latch or a hinged cover.

According to an embodiment, the method comprises lifting the guide rail elements one by one above a protective roof of the installation platform by means of the temporary hoist or material hoist and lowering the guide rail element through the hatch and the dedicated support openings until their lower ends meet the bottom surface of the guide rail basket.

According to an embodiment, the method comprises mounting at first a first lowermost section of guide rail elements without the help of the installation platform after which the following sections of the guide rails are installed on the installation platform.

According to an embodiment, the installation platform is supported to the already installed sections of the guide rails when moved in the elevator shaft.

According to an embodiment, the installation platform may be alternatively supported to the walls of the elevator shaft by means of rollers, slide elements, or other support elements.

According to an embodiment, the disclosed solution may be implemented in connection with the already existing and used installation platforms. Needed modifications to their structures are relatively easy to make with common hand tools. Thereby, the present solution is retrofittable to existing solutions.

According to an embodiment, the disclosed solution may be implemented in installation of guide rails of the elevator car. When the elevator is a traction elevator and comprises a counterweight, the disclosed solution can be implemented for mounting guide rails of the counterweight and a counterweight frame of other support arrangements of the counterweight.

According to an embodiment, the disclosed solution can be implemented also when the installation work is automated or semi-automated. Also, when the actual installation work is executed by means of one or more robots or remote controlled installing apparatuses, there still exists a need to transport the guide rail elements in the elevator shaft.

The above disclosed embodiments may be combined in order to form suitable solutions having those of the above features that are needed.

### BRIEF DESCRIPTION OF THE FIGURES

Some embodiments are described in more detail in the accompanying drawings, in which

FIG. 1 is a schematic and highly simplified side view of a traction elevator,

FIG. 2 is schematic top view of an elevator car assembly and a counterweight assembly and also their guide systems,

FIG. 3 is a schematic view of guide rails and connections between consecutive guide rail elements,

FIG. 4 is a schematic side view of an arrangement for transporting guide rail elements in an elevator shaft,

FIG. 5 is a schematic side view of an already installed guide rail element and a new following guide rail element aligned above it,

FIG. 6 is a schematic side view of an elevator shaft and loading of guide rail elements,

FIG. 7 is a schematic top view of part of a floor of an installation platform which is provided with shaped support openings,

FIG. 8 is a schematic view of a guide rail basket, and

FIG. 9 is a schematic view of loading measures of a guide rail basket with several guide rail elements.

For the sake of clarity, the figures show some embodiments of the disclosed solution in a simplified manner. In the figures, like reference numerals identify like elements.

### DETAILED DESCRIPTION OF SOME EMBODIMENTS

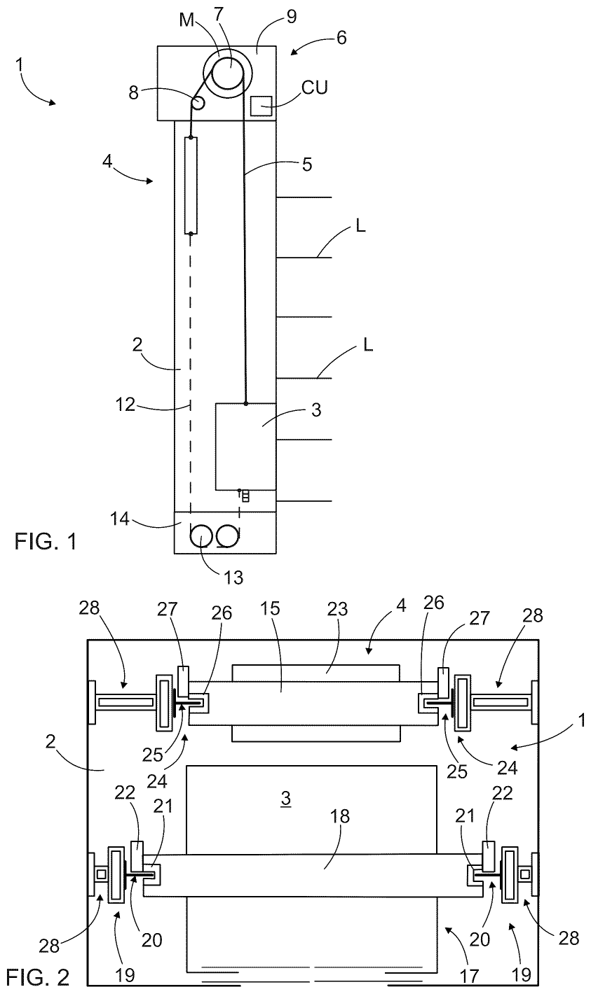

FIG. 1 discloses a traction elevator 1 mounted to an elevator shaft 2 of a building. The elevator 1 comprises an elevator car 3 for receiving load to be transported. The car 3 and a counterweight assembly 4 are suspended from a suspension rope 5 passing via a hoisting machinery 6. The hoisting machinery 6 comprises a traction sheave 7 driven by means of an electric motor M. Between the suspension rope 5 and the traction sheave 7 occurs friction which is utilized for transmitting lifting power to the elevator system. The hoisting machinery 6 may comprise one or more additional pulleys 8 for guiding and controlling the suspension rope 5. The hoisting machinery 6 may be located at an upper machine room 9, or alternatively the system may be a so called machine room less elevator. The car 3 can be driven to desired landings L or floors under control of one or more control units CU. Below a first landing there may be a pit 14 of an elevator shaft 2.

FIG. 2 shows that a car assembly 17 comprises an elevator car 3 and a support element 18. The car assembly 17 is supported to the elevator shaft 2 by means of a first guide rail 19 comprising first vertical guide rail elements 20 mounted to inner surfaces of the elevator shaft 2 and first guide shoes 21 mounted to the support element 18. There may also be breaking shoes 22 or devices as well as security arrangements at the guide assembly 19.

A counterweight assembly 4 comprises a counterweight frame 15 and filler elements 23. The frame 15 is supported to the elevator shaft 2 by means of a second guide rail 24 comprising second vertical guide rail element 25 and second guide shoes 26. Also the counterweight assembly 4 may be provided with breaking shoes 27 for decelerating movement of the counterweigh assembly 4.

FIG. 2 furthers shows that the guide rails 19 and 24 may be supported to the elevator shaft 2 by means of beam structures 28. Alternatively, the guide rails 19, 24 may be mounted directly to wall surfaces of the elevator shaft 2.

A cross-section of the guide rail element 20, 25 may have the form of a letter T having a flat bottom portion and a flat and protruding support portion at the middle section of the bottom portion. The guide rail element 20 may be attached with brackets or fixing elements from its bottom portion to the fixed structure.

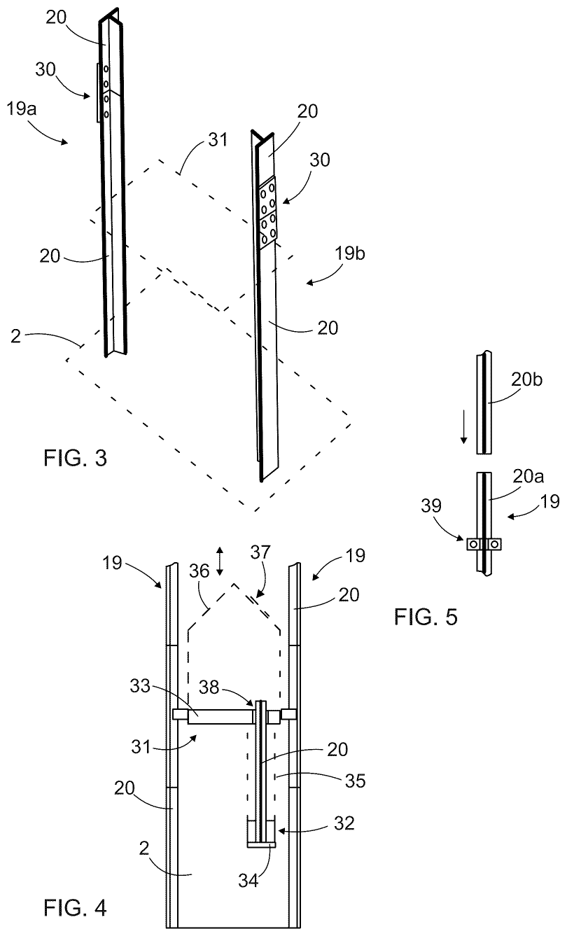

FIG. 3 discloses part of two opposing guide rails 19a, 19b and connecting elements 30 between two consecutive guide rail elements 20. An elevator shaft 2 is shown in broken lines as well as an installation platform 31 supported between the guide rails 19a, 19b.

FIG. 4 shows an arrangement for transporting guide rail elements 19 in an elevator shaft 2 by means of an installation platform 31 and a guide rail basket 32 supported below a floor 33 of the installation platform 31. The guide rail basket 32 comprises at least a bottom surface 34 for carrying several vertically loaded guide rail elements 20. The guide rail basket 32 is suspended by means of bendable supports 35. Upper ends of the guide rail elements 20 pass through the floor 33 of the installation platform 31 and extend a distance above so that handling and gripping of the guide rail elements is easy at an installation level.

FIG. 4 further discloses that the installation platform 31 may be driven vertically under support of previously installed guide rails 19. Moreover, the installation platform may be provided with a protective structure comprising a roof 36 for providing protection against falling objects. The guide rail elements may be loaded through an opening 37 in the roof 36 and through support openings 38 in the floor 33.

The installation platform 31 is intended for transporting one or more fitters or technicians and needed tools and mounting elements on it in the elevator shaft 2. The floor 33 may form a work surface for one or more fitters. Vertical support bars may extend between the floor 33 and the roof 36.

FIG. 5 discloses part of an already installed guide rail element 20a of a guide rail 19 and part of a new guide rail element 20b positioned in alignment with the previously installed guide rail element 20a. Then the new guide rail element 20b can be lowered by means of a hoisting device so that an end-to-end connection is possible between the guide rail elements 20a, 20b. Thereafter, the guide rail elements can be fixed to each other by means of suitable connection elements. The previously installed guide rail element 20a is mounted to a wall of an elevator shaft by means of brackets 39.

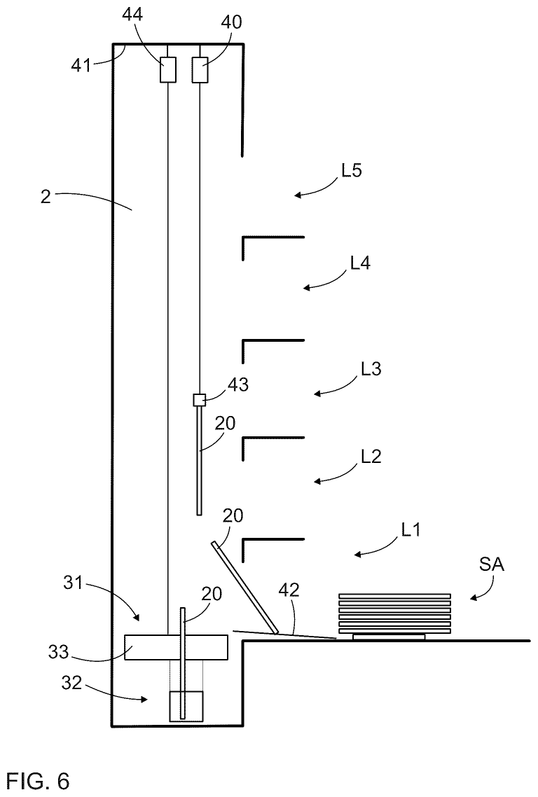

FIG. 6 shows loading of guide rail elements 20 onboard the above mentioned arrangement comprising the installation platform 31 and the hanging guide rail basket 32. FIG. 6 shows five landings L1-L5 or floors in the elevator shaft 2, but in high-rise buildings there are of course more landings. Number of the landings may be tens or even over one hundred. The guide rail elements 20 may be loaded at a lowermost first landing L1. There may be a storage area SA on the first landing L1 for the guide rail elements 20 to be installed. Alternatively, the storage area SA could naturally be arranged at any position below a working level of the guide rail installation. The storage area SA could first be positioned on the first landing L1 and then later relocated to a higher landing as the installation advances.

The guide rail elements 20 stored on the storage area SA can be lifted with a temporary hoister 40 to the disclosed arrangement. The temporary hoister 40 may be supported to a ceiling 41 or upper wall portion of the elevator shaft 2, or alternatively any other supporting arrangement may be utilized. There may be a sloping guide 42 or a sledge for assisting the lifting and protecting lower ends of the guide rail elements 20 during the lifting measures. The guide rail elements 20 may be gripped by means of a gripper 43. After the guide rail elements 20 are lifted into vertical hanging position above the installation platform 31, they are lowered through a floor 33 to the guide rail basket 32. The temporary hoister 40 and the gripper 43 are also implemented for unloading the guide rail elements 20 at the working landing whereto the arrangement is driven after being loaded at the lower landing level.

The installation platform 31 and the hanging guide rail basket 32 may be driven in the elevator shaft 2 by means of a hoisting device 44 which may also be supported to the ceiling 41 of the elevator shaft 2. Alternatively, the hoisting device 44 may be supported to any other support point. A further alternative is that arrangement is not suspended by means of ropes or wires from the hoisting device, but instead there may a hoisting apparatus which is located onboard the installation platform, and which may be in contact with the already installed guide rails when generating needed driving forces. Thus, any type of hoisting means is suitable for moving the arrangement vertically in the elevator shaft 2.

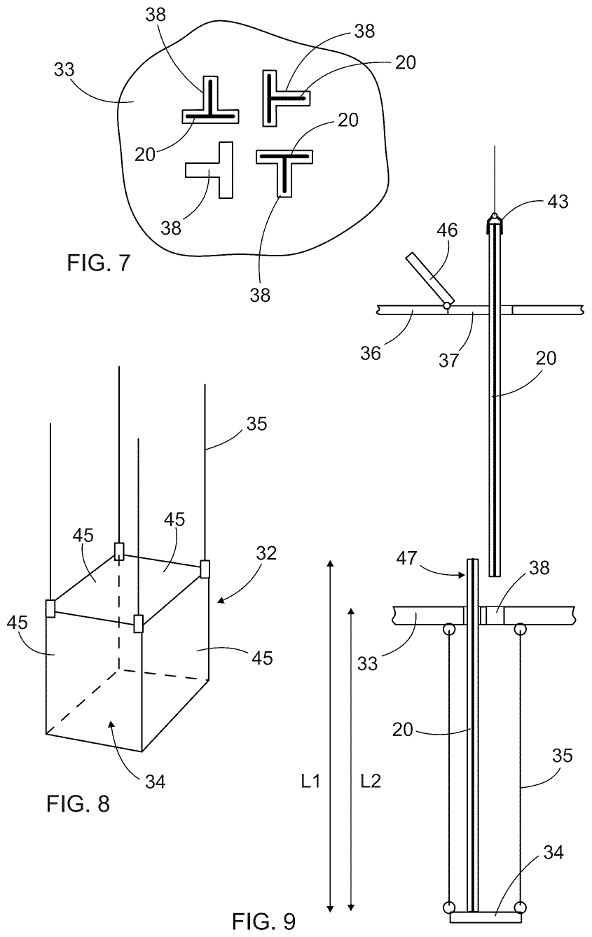

FIG. 7 discloses that a floor 33 of the installation platform may comprise several support openings 38 shape of which may be in accordance with cross-sectional shapes of the guide rail elements 20.

FIG. 8 discloses a guide rail basket 32 and four bendable supports 35, such as chains. The guide rail basket 32 comprises a bottom surface 34. There may also be side supports 45 extending above the bottom surface 34 and providing additional support for transported guide rail elements.

FIG. 9 discloses that guide rail elements 20 can be lifted above a protective structure of an installation platform 31 comprising a roof 36. The guide rail elements may be loaded through an opening 37 in the roof 36. The opening 37 may be provided with an openable hatch 46, which may be hinged, or may alternatively be a sliding latch. The guide rail element 20 may be lowered through a support opening 38 in a floor 33 of the installation platform 31. A lower end of the guide rail element 20 is supported against a bottom surface 34 of a guide rail basket and an opposite second end portion is supported by means of the support opening 38. Length L1 of the guide rail element 20 is greater than a distance L2 between the floor 33 and the bottom surface 34 whereby there is a protruding portion 47 for facilitating gripping during the unloading phase.

The disclosed solution may be used in low-rise or in high-rise buildings. The benefits of the solution are naturally greater in high-rise buildings. High rise buildings may have a hoisting height over 200 meters.

In the disclosed figures the elevator shaft is intended for only one elevator car. However, the disclosed solution can naturally be implemented in installations where the elevator shafts are intended for several elevator cars. In such elevator shafts the space may be divided into sub-shafts for each elevator car by means of partition elements, for example.

Further, implementation of the disclosed solution is not limited to the exemplary elevator disclosed in the Figures. The arrangement and method can be used when installing any type of elevator e.g., an elevator comprising a machine room or lacking a machine room, an elevator comprising a counterweight or lacking a counterweight. The counterweight may be positioned on either side wall, or on both side walls, or on the back wall of the elevator shaft. The drive, the motor, the traction sheave, and the machine brake could be positioned in a machine room or somewhere else in the elevator shaft. The guide rails of the elevator car may be positioned on opposite side walls of the shaft or on a back wall of the elevator shaft. Thus, the disclosed solution can be implemented in a versatile manner and especially in high-rise buildings with great hoisting heights.

The drawings and the related description are only intended to illustrate the idea of the invention. In its details, the invention may vary within the scope of the claims.

1. An arrangement for assisting installation of guide rails of an elevator to an elevator shaft;
wherein the arrangement comprises an installation platform suspended movably to the elevator shaft;
and wherein the installation platform is provided with at least one support element for supporting at least one guide rail element;
wherein
the mentioned support element is a guide rail basket supported to the installation platform and being vertically movable inside the elevator shaft together with the installation platform;
the guide rail basket is located below the installation platform at a vertical distance from the installation platform; and
the guide rail basket comprises at least a bottom surface configured to support several guide rail elements vertically between the guide rail basket and the installation platform.

2. The arrangement as claimed in claim 1, wherein
the installation platform comprises at least one support opening through which upper parts of the vertical guide rail elements are configured to pass and extend above a floor surface of the installation platform.

3. The arrangement as claimed in claim 1, wherein
the installation platform comprises several dedicated support openings whereby upper parts of each guide rail element is supported separately to the installation platform;
and shapes of the support openings correspond to cross-sectional shapes of the guide rail elements.

4. The arrangement as claimed in claim 1, wherein
the guide rail basket is supported below the installation platform by means of several bendable supports; and
lengths of the mentioned supports are dimensioned so that the vertical distance between the bottom surface of the guide rail basket and a floor of the installation platform is shorter than lengths of the guide rail elements.

5. The arrangement as claimed in claim 1, wherein
the guide rail basket is dimensioned to carry weight of 2-6 guide rail elements.

6. The arrangement as claimed in claim 1, wherein
the guide rail basket comprises side supports extending above the bottom surface of the guide rail basket.

7. The arrangement as claimed in claim 1, wherein
the installation platform is provided with two guide rail baskets.

8. The arrangement as claimed in claim 1, wherein
the installation platform is a temporary installation structure which is configured to be removed from the elevator shaft after the installation work is completed.

9. A method of installing guide rails of an elevator,
wherein the elevator comprises an elevator shaft, an elevator car and vertical guide rails for supporting the elevator car;
and wherein the method comprises:
providing the elevator shaft with an installation platform at least for the duration of the installation of the elevator;
transporting guide rail elements in the elevator shaft by means of the installation platform between a loading level and installation level, wherein the loading level has lower level in the elevator shaft compared to the installation level;
and installing the guide rail elements to wall structures of the elevator shaft at the installation level by means of at least one fitter travelling onboard the installation platform;
characterized by
hanging several guide rail elements vertically at least partly below the installation platform during the transport.

10. The method as claimed in claim 9, characterized by
suspending at least one guide rail basket below the installation platform; and
supporting lower ends of the vertical guide rail elements on the guide rail basket.

11. The method as claimed in claim 9, characterized by
supporting upper end portions of the vertical guide rail elements in lateral direction by means of a structure of a floor of the installation platform.

12. The method as claimed in claim 9, characterized by
providing a floor of the installation platform with several dedicated support openings each of which receives one guide rail element;
feeding the guide rail elements through the dedicated support openings in downward direction towards a bottom surface of a guide rail basket; and
carrying the guide rail elements in vertical direction only by support forces produced by the bottom surface of the guide rail basket.

13. The method as claimed in claim 9, characterized by
setting vertical distance between a bottom surface of the guide rail basket and a floor of the installation platform to be shorter than lengths of the transported guide rail elements whereby upper ends of the guide rail elements protrude above an upper surface of the floor;
gripping each guide rail element by means of a gripper at the protruding portion and lifting the guide rail element above the floor by means of a temporary hoister;
positioning the guide rail element vertically on top of an already installed topmost guide rail element, whereby the guide rail element is set on the row of already installed guide rail elements;
aligning the guide rail elements end-on-end one after the other;
attaching the successive guide rail elements to each other with connection pieces extending between the end portions of two consecutive guide rail elements; and
fastening the guide rail elements to walls of the elevator shaft with fixing means at support points along the height of the guide rail elements.

14. The method as claimed in claim 9, characterized by
providing the installation platform with a protective roof;
providing the protective roof with an openable hatch; and
loading the guide rail elements on the arrangement via the hatch.

15. The method as claimed in claim 9, characterized by
selecting number of the transported guide rail elements in one drive of the arrangement so that several successive sections and at least 10 meters height of the guide rails is mountable at the installation level at a time.
